(19) United States
(12) Patent Application Publication
(10) Pub. No.: US 2024/0266777 A1
(43) Pub. Date: Aug. 8, 2024

(54) CONNECTOR

(71) Applicant: SUMITOMO WIRING SYSTEMS, LTD., Mie (JP)

(72) Inventor: Hiroyuki MATSUOKA, Mie (JP)

(21) Appl. No.: 18/563,453

(22) PCT Filed: Jun. 3, 2022
(86) PCT No.: PCT/JP2022/022628

§ 371 Date: Nov. 22, 2023

(30) Foreign Application Priority Data
Jun. 4, 2021 (JP) 2021-094663

(51) Int. Cl. H01R 13/512; H01R 13/40; H01R 13/641

(52) U.S. Cl. CPC H01R 13/512; H01R 13/40; H01R 13/641

(57) ABSTRACT

A connector according to one aspect of the present disclosure is provided with two terminals (10), two wires (20) and a housing (30). The housing (30) includes a tubular portion (31) and a holding portion (43) projecting from the tubular portion (31) and configured to hold the two terminals (10) and the two wires (20). The housing (30) includes a rib (45) coupling an outer surface of a part of the holding portion (43) located between the two terminals (10) adjacent to each other and an outer surface of the tubular portion (31). The rib (45) including a recess (46).

### TECHNICAL FIELD

The present disclosure relates to a connector.

### BACKGROUND

Conventionally, a connector to be connected to a device such as an inverter is disclosed in Patent Document 1. A connector described in Patent Document 1 is provided with a plurality of terminal-equipped wires, a housing made of resin for holding the plurality of terminal-equipped wires, and a shield shell made of metal, configured to cover the housing and to be fixed to the device.

The housing includes a tubular body portion having an opening for exposing a plurality of terminals and a wire holding portion projecting toward an outer peripheral side of the body portion from the body portion.

### PRIOR ART DOCUMENT

### Patent Document

Patent Document 1: International Publication No. WO 2018/186338

### SUMMARY OF THE INVENTION

### Problems to be Solved

The wire holding portion is cantilevered from the body portion. In this case, the dimensional accuracy of the housing may be reduced due to the tilt of the wire holding portion with respect to the body portion during the injection molding of the housing. Thus, it is desired to suppress a reduction in the dimensional accuracy of the housing.

The present disclosure aims to suppress a reduction in the dimensional accuracy of a housing.

### Means to Solve the Problem

The present disclosure is directed to a connector with a plurality of terminals parallel to each other, a plurality of wires to be respectively connected to the plurality of terminals, and a housing made of resin and including a tubular portion having an opening for exposing end parts of the plurality of terminals and a holding portion projecting from the tubular portion toward an outer peripheral side of the tubular portion, the holding portion holding the plurality of terminals and the plurality of wires, the housing including a rib coupling an outer surface of a part of the holding portion located between two mutually adjacent ones of the terminals and an outer surface of the tubular portion, and the rib including a recess.

### Effect of the Invention

According to the present disclosure, it is possible to suppress a reduction in the dimensional accuracy of a housing.

### BRIEF DESCRIPTION OF THE DRAWINGS

FIG. 1 is a diagram of a vehicle equipped with connectors of one embodiment.

FIG. 2 is a perspective view of the connector.

FIG. 3 is an exploded perspective view of the connector.

FIG. 4 is a section of the connector.

FIG. 5 is a bottom view of a housing.

FIG. 6 is a perspective view of the housing.

FIG. 7 is a section along 7-7 of FIG. 4.

FIG. 8 is a side view of the housing.

FIG. 9 is a side view of the housing.

FIG. 10 is a section along 10-10 of FIG. 5 of the housing.

FIG. 11 is a section along 11-11 of FIG. 5 of the housing.

FIG. 12 is a perspective view of a first sealing member.

FIG. 13 is an exploded perspective view of a cover.

FIG. 14 is a plan view of the cover.

FIG. 15 is a perspective view of the cover.

FIG. 16 is a perspective view in section of the cover.

FIG. 17 is a section of the connector.

### DETAILED DESCRIPTION TO EXECUTE THE INVENTION

### Description of Embodiments of Present Disclosure

First, embodiments of the present disclosure are listed and described.
[1] The connector of the present disclosure is provided with a plurality of terminals parallel to each other, a plurality of wires to be respectively connected to the plurality of terminals, and a housing made of resin and including a tubular portion having an opening for exposing end parts of the plurality of terminals and a holding portion projecting from the tubular portion toward an outer peripheral side of the tubular portion, the holding portion holding the plurality of terminals and the plurality of wires, the housing including a rib coupling an outer surface of a part of the holding portion located between two mutually adjacent ones of the terminals and an outer surface of the tubular portion, and the rib including a recess.

According to this configuration, since the holding portion and the tubular portion are coupled by the rib, the tilt of the holding portion with respect to the tubular portion can be suppressed.

Further, according to the above configuration, during the injection molding of the housing, a part of a mold is arranged in a space where the recess is to be formed, and a resin material for constituting the housing is filled around this part. Thus, the rib is cooled, for example, by causing a refrigerant to flow inside the part of the mold. Since the rib can be solidified earlier than other parts in this way, the tilt of the holding portion with respect to the tubular portion can be suppressed. Therefore, a reduction in the dimensional accuracy of the housing can be suppressed.

Further, since the rib includes the recess according to the above configuration, it is possible to reduce the amount of the resin material used for the housing and reduce the weight of the housing.
[2] Preferably, if parts of the terminals to be connected to the wires are wire connecting portions, the rib projects from an outer surface of a part of the holding portion located between two mutually adjacent ones of the wire connecting portions.

According to this configuration, a part of the holding portion holding the wire connecting portions is less likely to tilt with respect to the tubular portion. In this way, it can be suppressed that load is generated in the wire connecting portions due to the tile of the holding portion. Therefore, the connection reliability of the terminals and the wires can be improved.
[3] Preferably, a cover is provided which covers the opening by being inserted into the tubular portion, the tubular portion has a first end part, the cover being inserted into the first end part, and a second end part located on a side opposite to the first end part in an axial direction of the tubular portion, the holding portion projects from the first end part, and the rib is provided on a side where the second end part is located when viewed from the holding portion.

For example, if the rib is provided on the side where the first end part is located when viewed from the holding portion, a length from the holding portion to an end edge of the first end part in the tubular portion may increase.

In this respect, since the rib is provided on the side where the second end part is located when viewed from the holding portion according to the above configuration, the length from the holding portion to the end edge of the first end part in the tubular portion can be reduced. Therefore, the size of the tubular portion in the axial direction, consequently the size of the connector in the axial direction, can be reduced.
[4] Preferably, the cover includes a separation wall made of resin and located between two mutually adjacent ones of the terminals.

According to this configuration, since the separation wall is located between the two mutually adjacent ones of the terminals, these two terminals can be suitably insulated from each other. Further, an insulation distance between the two terminals can be reduced as compared to the case of using a cover body including no separation wall. Therefore, an increase in the size of the connector in a parallel direction of the plurality of terminals can be suppressed.
[5] Preferably, the cover includes a facing wall located on a side opposite to the separation wall across one terminal fitting and facing the separation wall and a coupling wall located on a side opposite to the holding portion across the one terminal and coupling the separation wall and the facing wall, and the coupling wall is configured to restrict insertion of the cover into the tubular portion by contacting the terminal if the cover is inserted into the tubular portion while being inverted about a center axis of the tubular portion with respect to a proper posture.

According to this configuration, if the cover is inserted into the tubular portion while being inverted about the center axis of the tubular portion with respect to the proper posture, the insertion of the cover into the tubular portion is restricted by the contact of the coupling wall with the terminal. In this way, a worker easily notices the erroneous assembling of the cover with the tubular portion.
[6] Preferably, an interlock connector for electrically detecting whether or not the housing is connected to a connection target at a proper position is provided inside the tubular portion, and the interlock connector is provided in parallel to the plurality of terminals in the parallel direction of the plurality of terminals.

According to this configuration, the plurality of terminals and the interlock connector are provided in parallel in the parallel direction of the plurality of terminals. Thus, as compared to the case where the terminals and the interlock connector are arranged in parallel in a direction intersecting both the parallel direction and the axial direction, an increase in the size of the housing in the intersecting direction can be suppressed.
[7] Preferably, a cover is provided which covers the opening by being inserted into the tubular portion, the cover includes an accommodating portion for accommodating one end of the interlock connector, and the accommodating portion is configured to restrict insertion of the cover into the tubular portion by contacting the terminal if the cover is inserted into the tubular portion while being inverted about the center axis of the tubular portion with respect to the proper posture.

According to this configuration, if the cover is inserted into the tubular portion while being inverted about the center axis of the tubular portion with respect to the proper posture, the insertion of the cover into the tubular portion is restricted by the contact of the accommodating portion with the terminal. In this way, the worker easily notices the erroneous assembling of the cover with the tubular portion.
[8] Preferably, the tubular portion includes a partition wall partitioning inside of the tubular portion between the plurality of terminals and the interlock connector.

According to this configuration, since the partition wall is provided inside the tubular portion, an insulation distance between the plurality of terminals and the interlock connector can be reduced as compared to the case where the partition wall is not provided. Therefore, an increase in the size of the connector in the parallel direction of the plurality of terminals can be suppressed.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure. Note that the present disclosure is not limited to these illustrations, but is represented by claims and intended to include all changes in the scope of claims and in the meaning and scope of equivalents. “Orthogonal” in this specification means not only strictly orthogonal, but also substantially orthogonal within a range in which functions and effects in this embodiment are achieved.

### (Configurations of Wiring Harnesses W1, W2)

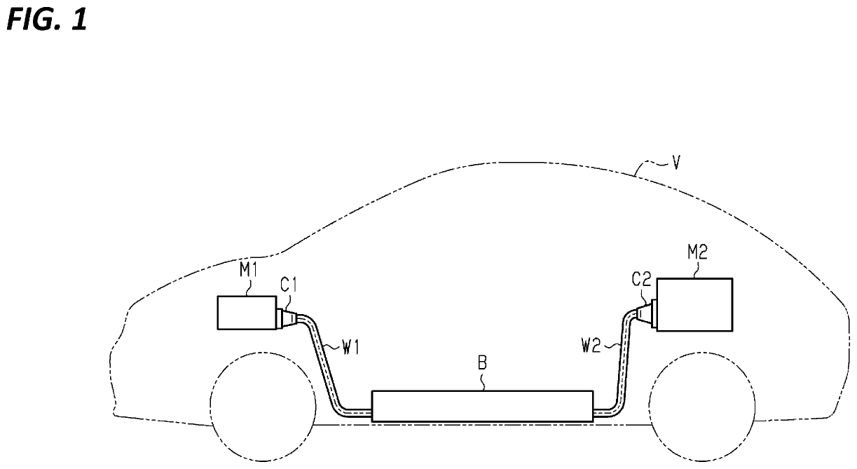

As shown in FIG. 1, wiring harnesses W1, W2 are routed in a vehicle V. The wiring harness W1 electrically connects, for example, an electric device M1 such as a motor arranged in a front part of the vehicle V and a battery B arranged in a floor part of the vehicle V. The wiring harness W2 electrically connects, for example, an electric device M2 such as a motor arranged in a rear part of the vehicle V and the battery B.

A connector C1 to be connected to the electric device M1 is provided on an end part of the wiring harness W1. A connector C2 to be connected to the electric device M2 is provided on an end part of the wiring harness W2. The configuration of the connector C1 and that of the connector C2 may be the same or may be different from each other. The electric device M1 corresponds to a “connection target”.

### (Configuration of Connector C1)

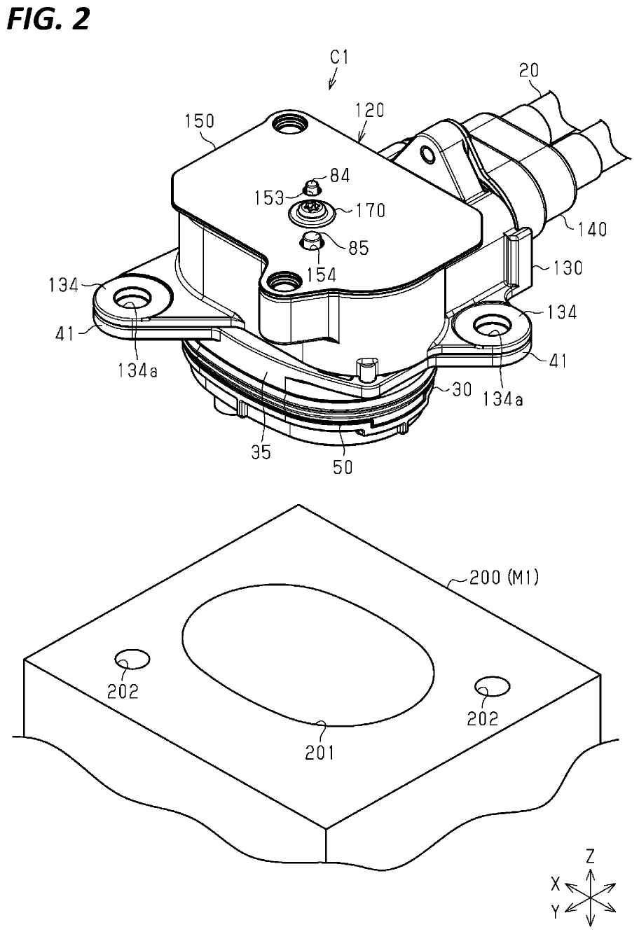

As shown in FIG. 2, the connector C1 is mounted on a case 200 of the electric device M1 while being partially inserted into an insertion hole 201 provided in the case 200.

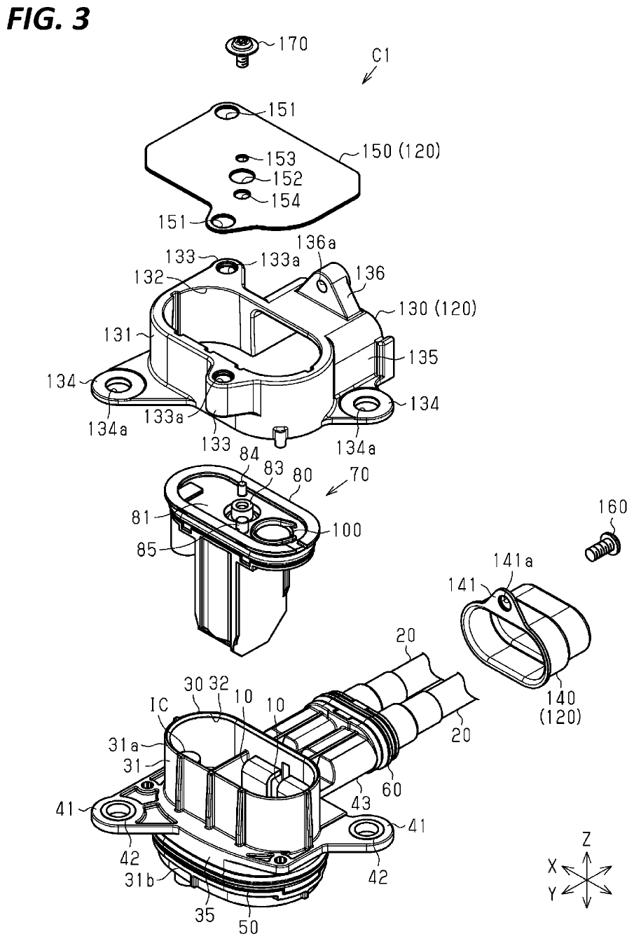

As shown in FIG. 3, the connector C1 is provided with a plurality of terminals 10, a plurality of wires 20, a housing 30, a cover 70 and a shield shell 120. The plurality of terminals 10 are parallel to each other. The plurality of wires 20 are respectively electrically connected to the plurality of terminals 10. The housing 30 holds the plurality of terminals 10 and the plurality of wires 20. The cover 70 covers a part of the housing 30. The shield shell 120 covers parts of the cover 70 and the housing 30.

The connector C1 is, for example, provided with two terminals 10 and two wires 20. Note that the connector C1 may be provided with three or more terminals 10 and three or more wires 20.

Out of X, Y and Z axes of each figure, the X axis extends in a parallel direction of the two terminals 10. The Y axis extends in a longitudinal direction of the wires 20. The Z axis extends in a mounting direction of the case 200 of the electric device M1 and the connector C1. The X, Y and Z axes are orthogonal to each other. A direction along the X axis is referred to as an X-axis direction, a direction along the Y axis is referred to as a Y-axis direction and a direction along the Z axis is referred to as a Z-axis direction below.

The connector C1 is mounted on the case 200, for example, in such a posture that the X-axis direction and a vertical direction coincide. Note that an up-down direction on the plane of each figure does not necessarily coincide with the vertical direction.

### (Configuration of Terminal 10)

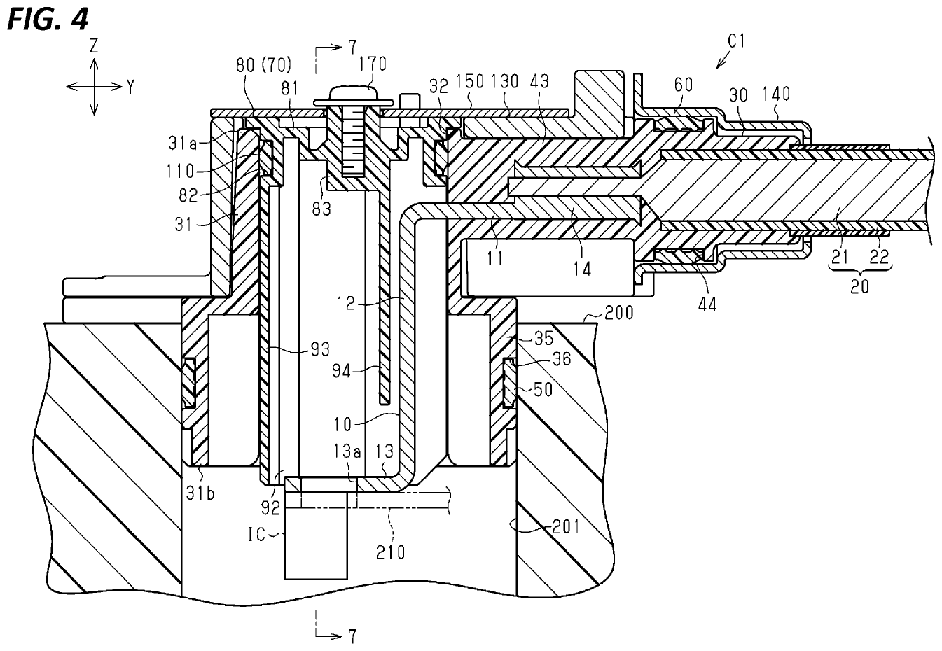

As shown in FIG. 4, the terminal 10 includes a first extending portion 11, a second extending portion 12 and a third extending portion 13. The terminal 10 is, for example, plate-like. An iron-based, copper-based or aluminum-based metal material can be, for example, cited as a material of the terminal 10.

The first extending portion 11 extends in the Y-axis direction. The first extending portion 11 includes a wire connecting portion 14 to be electrically connected to the wire 20. The wire connecting portion 14 is provided on an end part in the Y-axis direction of the first extending portion 11.

The second extending portion 12 extends in the Z-axis direction from an end part of the first extending portion 11 on a side opposite to the wire connecting portion 14 toward the case 200.

The third extending portion 13 extends toward a side opposite to the first extending portion 11 in an extending direction of the first extending portion 11, i.e. the Y-axis direction, from an end part of the second extending portion 12 on a side opposite to the first extending portion 11. The third extending portion 13 is located outside the housing 30.

The third extending portion 13 is provided with a bolt hole 13a penetrating in the Z-axis direction. The third extending portion 13 is electrically connected to a mating terminal 210 provided inside the case 200 by an unillustrated bolt inserted through the bolt hole 13a.

### (Configuration of Wire 20)

The wire 20 includes a core wire 21 and an insulation coating 22 covering the outer periphery of the core wire 21. A copper-based or aluminum-based metal material can be, for example, cited as a material of the core wire 21. A resin material mainly containing a polyolefin-based resin such as cross-linked polyethylene or cross-linked polypropylene can be cited as a material of the insulation coating 22.

The core wire 21 is, for example, a stranded wire formed by twisting a plurality of metal strands. A cross-sectional shape of the core wire 21 orthogonal to a length direction is, for example, a circular shape.

The core wire 21 is exposed from the insulation coating 22 at an end part of the wire 20. The core wire 21 exposed from the insulation coating 22 is electrically connected to the wire connecting portion 14 of the terminal 10, for example, by crimping.

### (Configuration of Housing 30)

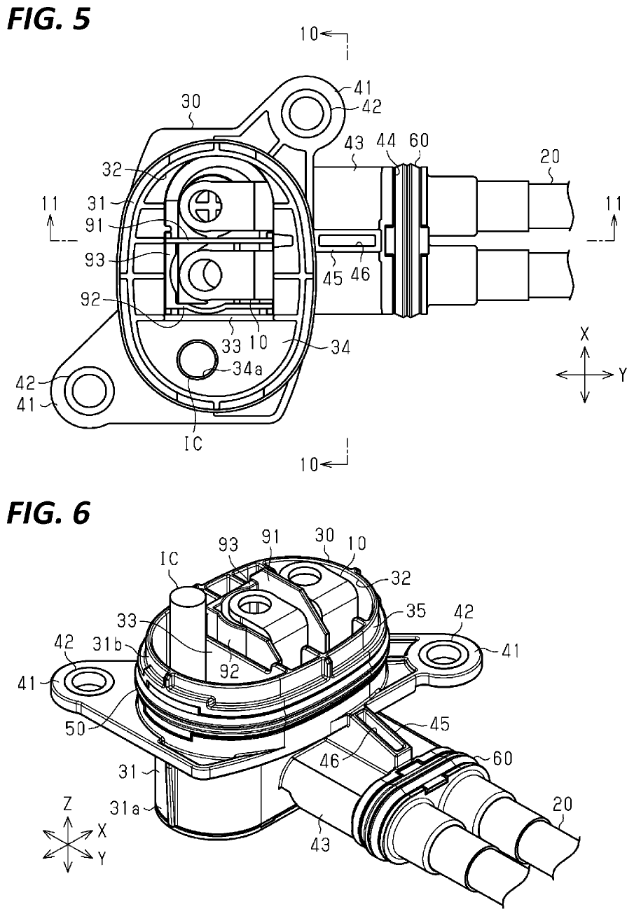

As shown in FIGS. 5 and 6, the housing 30 includes a tubular portion 31 and a holding portion 43. A resin material such as polybutylene terephthalate (PBT) can be cited as a material of the housing 30.

### (Configuration of Tubular Portion 31)

The tubular portion 31 includes an opening 32 through which the two terminals 10 are exposed. The opening 32 penetrates through the tubular portion 31 in the Z-axis direction. An axial direction of the tubular portion 31 coincides with the Z-axis direction. The opening edge of the tubular portion 31 has an elliptical shape long in the X-axis direction when viewed from the Z-axis direction.

An interlock connector IC is provided inside the tubular portion 31. The interlock connector IC is provided in parallel to the two terminals 10 in the X-axis direction.

The interlock connector IC is for electrically detecting whether or not the housing 30 is connected at a proper position with respect to the insertion hole 201 of the case 200. If the housing 30 is connected at the proper position with respect to the case 200, the interlock connector IC is connected to an unillustrated standby connector provided inside the case 200. An interlock circuit is configured by the interlock connector IC and the standby connector. If the interlock connector IC is connected to the standby connector, i.e. if the interlock circuit is closed, the connector C1 and the electric device M1 are in an energizable state.

As shown in FIG. 4, the tubular portion 31 has a first end part 31a and a second end part 31b located on sides opposite to each other in the Z-axis direction. The first end part 31a is a part of the tubular portion 31 on a side on which the cover 70 is mounted. The second end part 31b is a part of the tubular portion 31 to be inserted into the insertion hole 201 of the case 200.

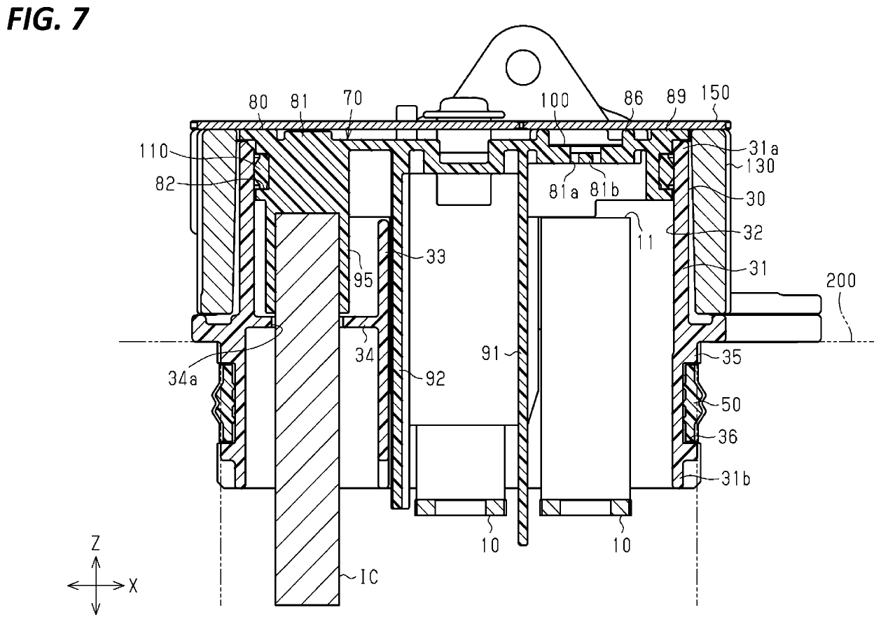

As shown in FIGS. 5 and 7, the tubular portion 31 includes a first partition wall 33 and a second partition wall 34. The first partition wall 33 corresponds to a “partition wall”.

The first partition wall 33 is for partitioning the inside of the tubular portion 31 between the two terminals 10 and the interlock connector IC. The first partition wall 33 extends in the Z-axis direction. The first partition wall 33 couples parts facing each other in the Y-axis direction, out of the inner wall of the tubular portion 31. Therefore, the inside of the tubular portion 31 is partitioned into a part where the two terminals 10 are located and a part where the interlock connector IC is located by the first partition wall 33.

The second partition wall 34 is for partitioning the part where the interlock connector IC is located, out of the inside of the tubular portion 31, in the Z-axis direction. The second partition wall 34 couples the inner wall of the tubular portion 31 and the first partition wall 33.

The second partition wall 34 is provided with an insertion hole 34a penetrating in the Z-axis direction. The interlock connector IC is inserted into the insertion hole 34a.

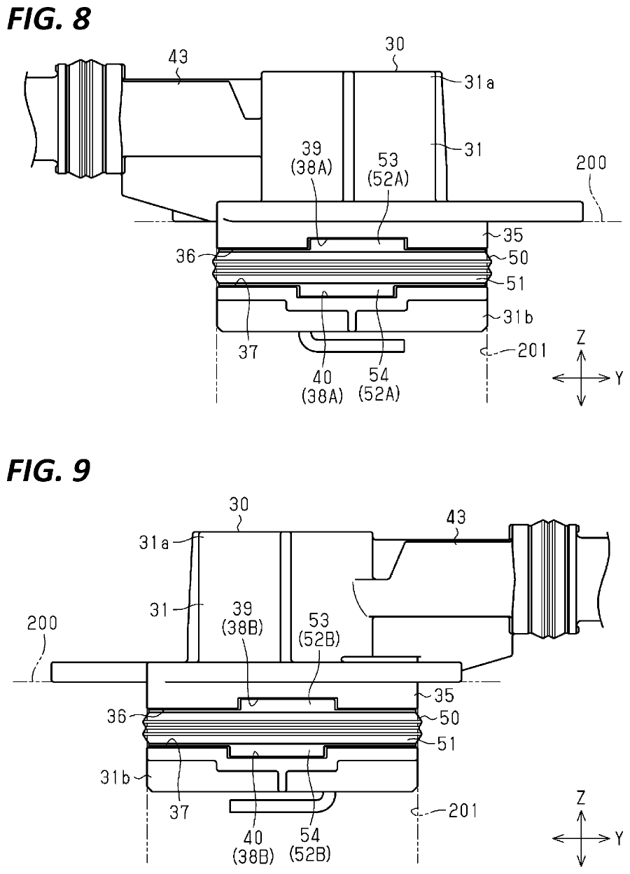

As shown in FIGS. 8 and 9, the tubular portion 31 is provided with an inserting portion 35 to be inserted into the insertion hole 201 of the case 200. The inserting portion 35 is a part including the second end part 31b, out of the tubular portion 31.

A first accommodation groove 36 is provided over an entire periphery in the outer peripheral surface of the inserting portion 35. An annular first sealing member 50 is accommodated into the first accommodation groove 36. An axial direction of the first sealing member 50 coincides with the Z-axis direction.

A circumferential direction of the first sealing member 50 is merely referred to as a circumferential direction below.

The first accommodation groove 36 includes a groove body 37 and two engaged portions 38A, 38B.

The groove body 37 has an annular shape extending over an entire periphery in the outer peripheral surface of the tubular portion 31.

The two engaged portions 38A, 38B are provided apart from each other in the circumferential direction. The two engaged portions 38A, 38B are located on sides opposite to each other across a center axis of the first sealing member 50. The two engaged portions 38A, 38B are respectively provided on one end and the other end in the X-axis direction of the groove body 37.

Each engaged portion 38A, 38B includes a first engaging groove 39 and a second engaging groove 40. The first and second engaging grooves 39, 40 extend toward sides opposite to each other in the Z-axis direction. The first engaging groove 39 extends from the groove body 37 toward a side where the first end part 31a is located in the Z-axis direction. The second engaging groove 40 extends from the groove body 37 toward a side where the second end part 31b is located in the Z-axis direction. The first and second engaging grooves 39, 40 have the same shape.

The first and second engaging grooves 39, 40 are provided at positions overlapping each other in the Z-axis direction. The first engaging groove 39 extends more toward one side in the circumferential direction than the second engaging groove 40. The second engaging groove 40 extends more toward the other side in the circumferential direction than the first engaging groove 39.

“One side in the circumferential direction” in this embodiment means a counterclockwise direction when the second end part 31b is viewed from the first end part 31a of the tubular portion 31 in the Z-axis direction, and the “other side in the circumferential direction” means a clockwise direction.

The first engaging groove 39 of the engaged portion 38A and the second engaging groove 40 of the engaged portion 38B are provided at the same position in the Y-axis direction. The first engaging groove 39 of the engaged portion 38B and the second engaging groove 40 of the engaged portion 38A are provided at the same position in the Y-axis direction.

As shown in FIGS. 5 and 6, the tubular portion 31 includes two fixing portions 41 projecting toward an outer peripheral side of the tubular portion 31. The two fixing portions 41 project toward sides opposite to each other in a direction intersecting both the X-axis direction and Y-axis direction in an XY plane. Each fixing portion 41 is provided with a tubular collar 42 made of metal. Each collar 42 penetrates in the Z-axis direction.

### (Configuration of Holding Portion 43)

As shown in FIG. 4, the holding portion 43 projects from the first end part 31a of the tubular portion 31 toward the outer peripheral side of the tubular portion 31, more specifically toward one side in the Y-axis direction. The holding portion 43 holds the two terminals 10 and the two wires 20. End parts of the wires 20, the wire connecting portions 14 and parts of the first extending portions 11 are embedded in the holding portion 43. The two terminals 10, the two wires 20 and the housing 30 are integrated by insert molding. Each wire 20 is pulled out from the holding portion 43 toward the one side in the Y-axis direction.

A second accommodation groove 44 is provided over an entire periphery in the outer peripheral surface of the holding portion 43. An annular second sealing member 60 is accommodated into the second accommodation groove 44.

### (Configuration of Rib 45)

As shown in FIG. 6, the housing 30 includes a rib 45 coupling the outer surface of the holding portion 43 and the outer surface of the tubular portion 31. The rib 45 is provided on a side where the second end part 31b is located when viewed from the holding portion 43.

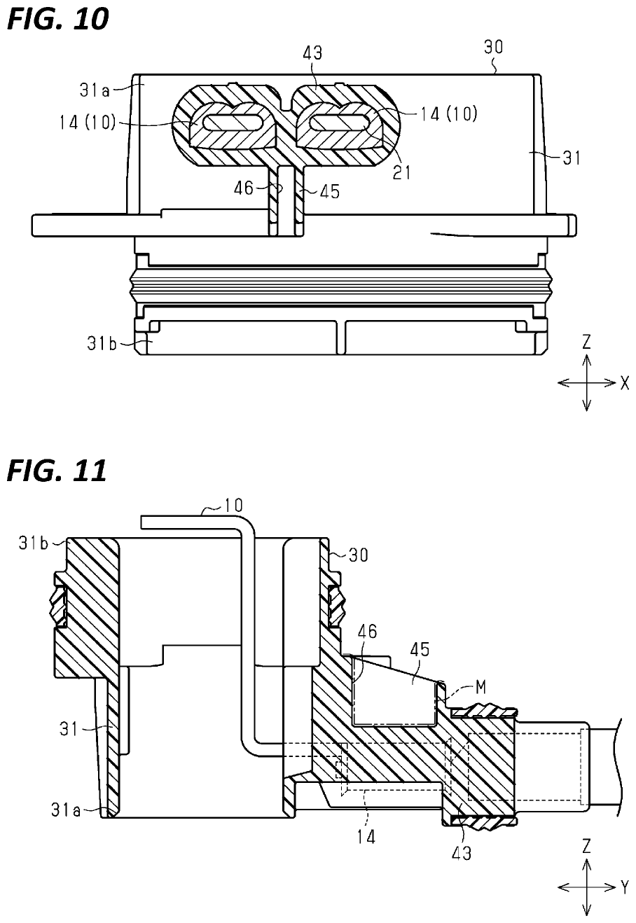

As shown in FIG. 10, the rib 45 projects from the outer surface of a part of the holding portion 43 located between the two terminals 10 adjacent to each other. That is, the rib 45 is located between the two terminals 10 in the X-axis direction. The rib 45 is provided at a position deviated toward one side in the X-axis direction from a central part in the X-axis direction of the outer surface of the tubular portion 31.

As shown in FIG. 11, the rib 45 is provided at a position overlapping the two wire connecting portions 14 in the Y-axis direction. Therefore, the rib 45 projects from the outer surface of a part of the holding portion 43 located between the two wire connecting portions 14 adjacent to each other.

The rib 45 includes a recess 46. The recess 46 is recessed in a direction from the second end part 31b toward the first end part 31a along the Z-axis direction. A cross-sectional shape of the recess 46 orthogonal to the Z-axis direction is, for example, a rectangular shape long in the Y-axis direction. This cross-sectional shape is the same over the entire recess 46 in the Z-axis direction. That is, the inner wall of the rib 45 forming the recess 46 extends in the Z-axis direction over the entire periphery of the recess 46. As shown by a two-dot chain line in FIG. 11, the recess 46 is so configured that a mold M used during the injection-molding of the housing 30 is insertable thereinto.

A projecting amount of the rib 45 from the outer surface of the holding portion 43 decreases with distance from the tubular portion 31 in the Y-axis direction.

### (Configuration of First Sealing Member 50)

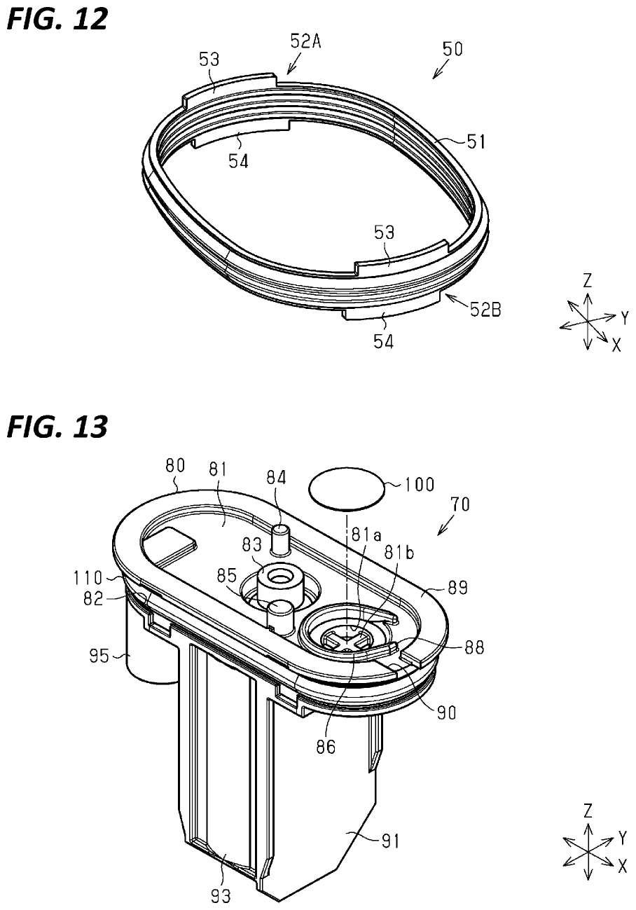

As shown in FIG. 12, the first sealing member 50 includes a sealing body 51 and two engaging portions 52A, 52B.

The sealing body 51 has an annular shape long in the X-axis direction. The sealing body 51 is provided with lips projecting toward an outer peripheral side over an entire periphery. The sealing body 51 is accommodated into the groove body 37 of the first accommodation groove 36.

The two engaging portions 52A, 52B are provided apart from each other in the circumferential direction. The two engaging portions 52A, 52B are located on sides opposite to each other across the center axis of the first sealing member 50. The two engaging portions 52A, 52B are respectively provided on one end and the other end in the X-axis direction of the sealing body 51.

As shown in FIGS. 8 and 9, each engaging portion 52A, 52B includes a first engaging projection 53 and a second engaging projection 54. The first and second engaging projections 53, 54 project from the sealing body 51 toward sides opposite to each other in the Z-axis direction. The first engaging projection 53 extends from the sealing member 51 toward the side where the first end part 31a is located in the Z-axis direction. The second engaging projection 54 extends from the sealing member 51 toward the side where the second end part 31b is located in the Z-axis direction. The first and second engaging projections 53, 54 have the same shape.

The first and second engaging projections 53, 54 are provided at positions overlapping each other in the Z-axis direction. The first engaging projection 53 projects more toward one side in the circumferential direction than the second engaging projection 54. The second engaging projection 54 projects more toward the other side in the circumferential direction than the first engaging projection 53. The first and second engaging projections 53, 54 are respectively engaged with the first and second engaging grooves 39, 40.

The first engaging projection 53 of the engaging portion 52A and the second engaging projection 54 of the engaging portion 52B are provided at the same position in the Y-axis direction. The first engaging projection 53 of the engaging portion 52B and the second engaging projection 54 of the engaging portion 52A are provided at the same position in the Y-axis direction.

From the above, the sealing member 50 is shaped to be point symmetric with each of the X, Y and Z axes as an axis of symmetry. That is, if the first sealing member 50 is inverted with each of the X, Y and Z axes as a center axis, the shapes of the first sealing member 50 before and after inversion overlap each other.

By accommodating the first sealing member 50 into the first accommodation groove 36, water is stopped between the inserting portion 35 and the insertion hole 201 of the case 200. Note that since the inserting portion 35 is located outside the shield shell 120, the first sealing member 50 is located outside the shield shell 120.

### (Configuration of Cover 70)

As shown in FIG. 7, the cover 70 covers the opening 32 of the tubular portion 31 by being inserted into the tubular portion 31 from the first end part 31a.

As shown in FIG. 13, the cover 70 includes a cover body 80 and a breathable film 100. A resin material such as polybutylene terephthalate (PBT) can be cited as a material of the cover body 80. A porous resin material or the like can be cited as a material of the breathable film 100.

The cover body 80 includes a lid portion 81 for covering the opening 32 of the tubular portion 31. The lid portion 81 has an elliptical shape long in the X-axis direction when viewed from the Z-axis direction.

A third accommodation groove 82 is provided over an entire periphery in the outer peripheral surface of the lid portion 81. An annular third sealing member 110 is accommodated into the third accommodation groove 82.

The lid portion 81 includes a vent 81a penetrating through the lid portion 81 in the Z-axis direction. The vent 81a is provided at a position deviated toward one side in the X-axis direction from a central part of the lid portion 81.

The breathable film 100 covers the vent 81a from a side opposite to the two terminals 10 in the Z-axis direction (see FIG. 7). The breathable film 100 has a circular shape when viewed from the Z-axis direction. A diameter of the breathable film 100 is larger than that of the vent 81a. The breathable film 100 is, for example, fixed to the lid portion 81 by being fused.

The breathable film 100 is configured to allow the passage of gases such as air and inhibit the passage of liquids such as water. A pressure difference between the inside and outside of the tubular portion 31 is reduced by the breathable film 100.

The vent 81a is provided with an X-shaped partitioning portion 81b partitioning the vent 81a. The touch of worker's fingers with the breathable film 100 through the vent 81a is suppressed by the partitioning portion 81b of the vent 81a.

As shown in FIG. 7, a gap is provided in the Z-axis direction between the breathable film 100 and the partitioning portion 81b. Since the breathable film 100 is less likely to be closed by the partitioning portion 81b due to this gap, the passage of gasses through the breathable film 100 is less likely to be inhibited.

As shown in FIGS. 3 and 13, the lid portion 81 includes a boss 83 projecting toward the side opposite to the two terminals 10 in the Z-axis direction. The boss 83 projects from a central part of the lid portion 81 in both the X-axis direction and Y-axis direction. The boss 83 has a hollow cylindrical shape having one end closed. The boss 83 is provided with a fastening hole, into which a tap screw 170 including a washer is fastened. The fastening hole is open toward the side opposite to the two terminals 10 in the Z-axis direction.

The lid portion 81 includes a first supporting protrusion 84 and a second supporting protrusion 85. Each supporting protrusion 84, 85 projects toward the side opposite to the two terminals 10 in the Z-axis direction. The first and second supporting protrusions 84, 85 are located on sides opposite to each other across the boss 83 in a direction intersecting both the X-axis direction and Y-axis direction in an XY plane. The first supporting protrusion 84 is located on a side where the holding portion 43 is located in the Y-axis direction when viewed from the boss 83.

Each supporting protrusion 84, 85 has a cylindrical shape. A diameter of the first supporting protrusion 84 is smaller than that of the second supporting protrusion 85.

As shown in FIG. 13, the lid portion 81 includes an inner wall 86 and an outer wall 89 respectively projecting in the Z-axis direction. The inner wall 86 surrounds the outer periphery of the breathable film 100. The outer wall 89 is located on an outer peripheral side of the inner wall 86 and forms the outer peripheral edge of the cover body 80. That is, the outer wall 89 includes the outer peripheral edge of the cover body 80.

The end surfaces in the Z-axis direction of the inner wall 86 and the outer wall 89 are flush with each other. Note that the aforementioned boss 83 and first and second supporting protrusions 84, 85 project beyond the end surfaces in the Z-axis direction of the inner wall 86 and the outer wall 89.

The outer peripheral edge of the outer wall 89 is located radially outward of the opening 32 of the tubular portion 31. The outer wall 89 covers an end surface in the Z-axis direction of the first end part 31a of the tubular portion 31 (see FIG. 7).

The inner wall 86 includes an inner discharge port 88 allowing communication between the inside and outside of the inner wall 86 in a direction orthogonal to the Z-axis direction. The outer wall 89 includes an outer discharge port 90 allowing communication between the inside and outside of the outer wall 89 in a direction orthogonal to the Z-axis direction. The inner and outer discharge ports 88, 90 are oriented in mutually different directions. The entire inner discharge port 88 is facing the inner peripheral surface of the outer wall 89. The entire outer discharge port 90 is facing the outer peripheral surface of the inner wall 86.

A virtual axis extending in a communicating direction of the inner discharge port 88 is referred to as a first virtual axis L1, and a virtual axis extending in a communicating direction of the outer discharge port 90 is referred to as a second virtual axis L2. Further, an intersection of the first and second vertical axes L1, L2 is referred to as an intersection P.

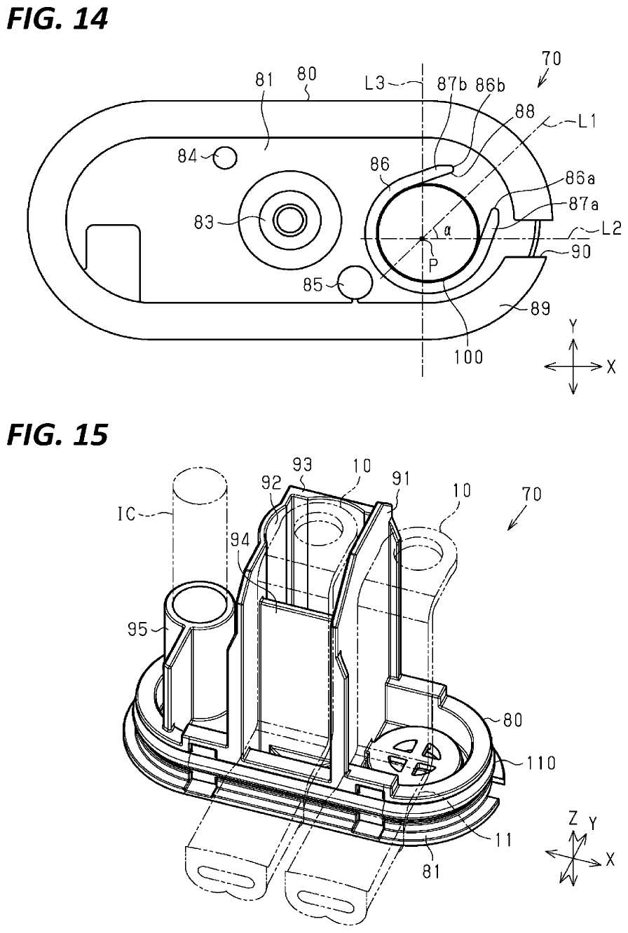

As shown in FIG. 14, the second virtual axis L2 extends in the X-axis direction. The first virtual axis L1 extends obliquely to the second virtual axis L2 in the XY plane. An angle α between the first and second virtual axes L1, L2 is an acute angle.

The entire inner discharge port 88 is closer to a side where the outer discharge port 90 is located than the intersection P in an axial direction of the second virtual axis L2, i.e. the X-axis direction. In other words, the entire inner discharge port 88 is located closer to the side where the outer discharge port 90 is located than a third virtual axis L3 extending in the Y-axis direction and passing through the intersection P.

If the outer discharge port 90 is oriented in a direction of 6 o'clock, the inner discharge port 88 is preferably oriented, for example, to a region between 3 o'clock and 9 o'clock. However, a case where the entire inner discharge port 88 is not facing the inner peripheral surface of the outer wall 89 is excluded.

The inner wall 86 has a first end edge 86a and a second end edge 86b forming the inner discharge port 88. The first end edge 86a is located closer to the outer discharge port 90 than the second end edge 86b.

The inner wall 86 is provided with a first extending portion 87a extending to include the first end edge 86a and a second extending portion 87b extending to include the second end edge 86b. The first and second extending portions 87a, 87b are facing each other.

A part of the inner wall 86 except the first and second extending portions 87a, 87b forms, for example, an arcuate shape along the outer peripheral edge of the breathable film 100. The first and second extending portions 87a, 87b extend, for example, straight. The first and second extending portions 87a, 87b extend to approach each other toward the inner discharge port 88.

The first extending portion 87a extends obliquely to the second virtual axis L2 to approach the outer discharge port 90 in the axial direction of the second virtual axis, i.e. the X-axis direction, toward the first end edge 86a.

As shown in FIG. 15, the cover 70 includes a separation wall 91, a facing wall 92, a first coupling wall 93 and a second coupling wall 94 respectively projecting from the lid portion 81 into the tubular portion 31 in the Z-axis direction.

The separation wall 91 is located between the two terminals 10 adjacent to each other. The separation wall 91 extends over the entire lid portion 81 in the Y-axis direction. Parts of the two terminals 10 located inside the opening 32 of the tubular portion 31 are located on sides opposite to each other across the separation wall 91. The separation wall 91 projects to a position beyond the two terminals 10 in the Z-axis direction.

The facing wall 92 is located on a side opposite to the separation wall 91 across one terminal 10. The facing wall 92 is facing the separation wall 91 in the X-axis direction. The facing wall 92 extends substantially over the entire lid portion 81 in the Y-axis direction. A projecting amount of the facing wall 92 from the lid portion 81 is less than that of the separation wall 91 from the lid portion 81.

As shown in FIGS. 4 and 15, the first coupling wall 93 is located on a side opposite to the holding portion 43 across the one terminal 10. The first coupling wall 93 couples the separation wall 91 and the facing wall 92. A projecting amount of the first coupling wall 93 from the lid portion 81 is equal to that of the facing wall 92 from the lid portion 81.

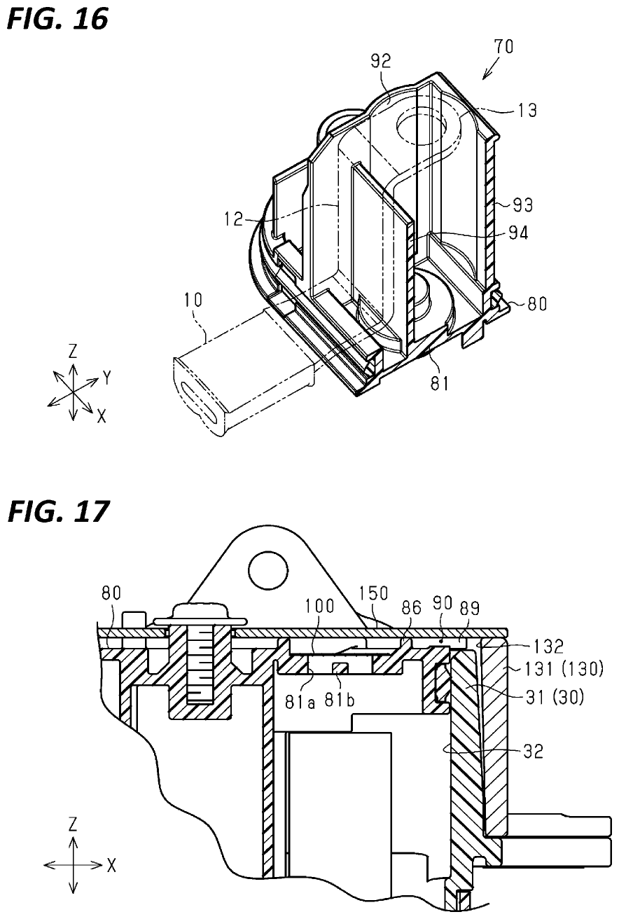

As shown in FIGS. 4 and 16, the second coupling wall 94 is located between the first coupling wall 93 and the second extending portion 12 of the one terminal 10. The second coupling wall 94 couples the separation wall 91 and the facing wall 92. A projecting amount of the second coupling wall 94 from the lid portion 81 is less than that of the first coupling wall 93 from the lid portion 81. A gap is provided between the second coupling wall 94 and the terminal 10 over the entire second coupling wall 94.

Here, the first coupling wall 93 is configured to restrict the insertion of the cover 70 into the tubular portion 31 by contacting the first extending portion 11 of the terminal 10 if the cover 70 is inserted into the tubular portion 31 while being inverted about a center axis of the tubular portion 31 with respect to a proper posture. In this embodiment, the projecting amount of the first coupling wall 93 from the lid portion 81 is larger than a distance from the lid portion 81 to the first extending portion 11 in the Z-axis direction. In this way, the first coupling wall 93 contacts the first extending portion 11 if the cover 70 is inserted in the inverted state into the tubular portion 31.

As shown in FIGS. 7 and 15, the cover 70 includes an accommodating portion 95 projecting from the lid portion 81 into the tubular portion 31 and configured to accommodate one end of the interlock connector IC. The accommodating portion 95 has a hollow cylindrical shape having one end closed.

A projecting amount of the accommodating portion 95 from the lid portion 81 is less than that of each of the separation wall 91, the facing wall 92, the first coupling wall 93 and the second coupling wall 94 from the lid portion 81 and larger than the distance from the lid portion 81 to the first extending portion 11 of the terminal 10 in the Z-axis direction.

Here, if the cover 70 does not include the first coupling wall 93 and is inserted into the tubular portion 31 while being inverted about the center axis of the tubular portion 31 with respect to the proper posture, the accommodating portion 95 is provided at a position capable of contacting the first extending portion 11 of the terminal 10. That is, the accommodating portion 95 is configured to restrict the insertion of the cover 70 into the tubular portion 31 by contacting the terminal 10 if the cover 70 does not include the first coupling wall 93.

An unillustrated shorting pin is provided inside the accommodating portion 95. By accommodating the interlock connector IC into the accommodating portion 95, unillustrated two terminals provided inside the interlock connector IC are electrically connected via the shorting pin. In this way, the circuit inside the interlock connector IC enters an electrically conductive state.

### (Configuration of Shield Shell 120)

As shown in FIGS. 2 and 3, the shield shell 120 includes a first shell 130, a second shell 140 and a third shell 150. An iron-based or aluminum-based metal material can be, for example, cited as a material of each shell 130, 140, 150.

### (Configuration of First Shell 130)

As shown in FIG. 3, the first shell 130 includes a first part 131 and a second part 135. The first part 131 covers the outer periphery of a part of the tubular portion 31 on a side opposite to the inserting portion 35. The second part 135 covers the outer periphery of a part of the holding portion 43. The first and second parts 131, 135 are open toward the case 200 in the Z-axis direction.

The first shell 130 includes an opening 132, into which the tubular portion 31 is inserted. The opening 132 has an elliptical shape long in the X-axis direction when viewed from the Z-axis direction.

As shown in FIG. 17, the first part 131 covers the outer discharge port 90 of the cover body 80 from an outer peripheral side of the outer wall 89.

As shown in FIG. 3, the first part 131 includes two fixing projections 133 projecting toward an outer peripheral side of the opening 132. Each fixing projection 133 is provided with a screw hole 133a penetrating in the Z-axis direction.

The first part 131 includes two fixing portions 134 projecting toward the outer peripheral side of the opening 132. The two fixing portions 134 are provided at positions respectively corresponding to the two fixing portions 41 of the housing 30. Each fixing portion 134 is provided with a through hole 134a penetrating in the Z-axis direction. The through hole 134a communicates with the collar 42 provided in the fixing portion 41. As shown in FIG. 2, the connector C1 is fixed to the case 200 by fastening unillustrated bolts inserted through the fixing portions 134, 41 into screw holes 202 provided in the case 200.

As shown in FIG. 3, the second part 135 includes a projecting portion 136 projecting toward a side opposite to the holding portion 43 in the Z-axis direction. The projecting portion 136 is provided with a screw hole 136a penetrating in the Y-axis direction.

### (Configuration of Second Shell 140)

The second shell 140 has a tubular shape. The second shell 140 covers the outer periphery of a part of the holding portion 43 not covered by the second part 135.

The second shell 140 includes a projecting portion 141 projecting toward the side opposite to the holding portion 43 in the Z-axis direction. The projecting portion 141 is provided with a screw hole 141a penetrating in the Y-axis direction. The second shell 140 is fixed to the first shell 130 by fastening a bolt 160 inserted through the through hole 141a into the screw hole 136a of the first shell 130.

Although not shown, a braided member made of metal for collectively covering the two wires 20 is mounted on the outer peripheral surface of the second shell 140 by a crimp ring.

### (Configuration of Third Shell 150)

The third shell 150 is in the form of a flat plate extending in an XY plane. The third shell 150 covers the opening 32 of the tubular portion 31 and the opening 132 of the first shell 130. In this way, the cover 70 is covered by the third shell 150 from the side opposite to the case 200 in the Z-axis direction.

As shown in FIG. 7, the third shell 150 is in contact with the end surfaces in the Z-axis direction of the inner wall 86 and the outer wall 89 of the cover body 80.

As shown in FIG. 3, the third shell 150 includes two through holes 151 respectively communicating with the two screw holes 133a of the first shell 130. The third shell 150 is fixed to the first shell 130 by unillustrated bolts inserted through the respective through holes 151.

The third shell 150 includes a boss insertion hole 152, into which the boss 83 of the cover 70 is inserted. A diameter of the boss insertion hole 152 is larger than that of the boss 83. The diameter of the boss insertion hole 152 is smaller than that of the washer of the aforementioned tap screw 170. Note that, as shown in FIG. 4, a gap is provided in the Z-axis direction between this washer and the third shell 150.

As shown in FIG. 3, the third shell 150 includes a first insertion hole 153 and a second insertion hole 154, into which the first and second supporting protrusion 84, 85 are respectively inserted. A diameter of the first insertion hole 153 is larger than that of the first supporting protrusion 84. A diameter of the second insertion hole 154 is larger than that of the second supporting protrusion 85.

From the above, gaps are respectively provided between the boss 83 and the boss insertion hole 152, between the first supporting protrusion 84 and the first insertion hole 153 and between the second supporting protrusion 85 and the second insertion hole 154. The third shell 150 is configured to be swingable in a direction orthogonal to the Z-axis direction with respect to the cover 70 within the ranges of these gaps. In this way, the worker can easily align the positions of the through holes 151 and the screw holes 133a.

Functions and effects of this embodiment are described.
(1) The connector C1 is provided with the two terminals 10, the two wires 20 and the housing 30. The housing 30 includes the tubular portion 31 and the holding portion 43 projecting from the tubular portion 31 and configured to hold the two terminals 10 and the two wires 20. The housing 30 includes the rib 45 coupling the outer surface of the part of the holding portion 43 located between the two terminals 10 adjacent to each other and the outer surface of the tubular portion 31. The rib 45 includes the recess 46.

According to this configuration, since the holding portion 43 and the tubular portion 31 are coupled by the rib 45, the tilt of the holding portion 43 with respect to the tubular portion 31 can be suppressed.

Further, according to the above configuration, during the injection molding of the housing 30, a part of the mold M is arranged in a space where the recess 46 is to be formed, and the resin material for constituting the housing 30 is filled around this part. Thus, the rib 45 is cooled, for example, by causing a refrigerant to flow inside the part of the mold M. Since the rib 45 can be solidified earlier than other parts in this way, the tilt of the holding portion 43 with respect to the tubular portion 31 can be suppressed. Therefore, a reduction in the dimensional accuracy of the housing 30 can be suppressed.

Further, since the rib 45 includes the recess 46 according to the above configuration, it is possible to reduce the amount of the resin material used for the housing 30 and reduce the weight of the housing 30.
(2) The rib 45 projects from the outer surface of the part of the holding portion 43 located between the two wire connecting portions 14 adjacent to each other.

According to this configuration, the part of the holding portion 43 holding the wire connecting portions 14 is less likely to tilt with respect to the tubular portion 31. In this way, it can be suppressed that load is generated in the wire connecting portion 14 due to the tilt of the holding portion 43. Therefore, the connection reliability of the terminals 10 and the wires 20 can be improved.
(3) The holding portion 43 projects from the first end part 31a of the tubular portion 31. The rib 45 is provided on the side where the second end part 31b of the tubular portion 31 is located when viewed from the holding portion 43.

For example, if the rib 45 is provided on the side where the first end part 31a is located when viewed from the holding portion 43, a length from the holding portion 43 to an end edge of the first end part 31a in the tubular portion 31 may increase.

In this respect, since the rib 45 is provided on the side where the second end part 31b is located when viewed from the holding portion 43 according to the above configuration, the length from the holding portion 43 to the end edge of the first end part 31a in the tubular portion 31 can be reduced. Therefore, the size of the tubular portion 31 in the Z-axis direction, consequently the size of the connector C1 in the Z-axis direction, can be reduced.
(4) The cover body 80 of the cover 70 includes the separation wall 91 located between the two terminals 10 adjacent to each other.

According to this configuration, since the separation wall 91 is located between the two terminals 10 adjacent to each other, these two terminals 10 can be suitably insulated from each other. Further, an insulation distance between the two terminals 10 can be reduced as compared to the case of using the cover body 80 not including the separation wall 91. Therefore, it is possible to suppress an increase in the size of the connector C1 in the parallel direction of the two terminals 10, i.e. the X-axis direction.
(5) The cover body 80 of the cover 70 includes the facing wall 92 facing the separation wall 91 and the first coupling wall 93 coupling the separation wall 91 and the facing wall 92. The first coupling wall 93 is configured to restrict the insertion of the cover 70 into the tubular portion 31 by contacting the terminal 10 if the cover 70 is inserted into the tubular portion 31 while being inverted about the center axis of the tubular portion 31 with respect to the proper posture.

According to this configuration, if the cover 70 is inserted into the tubular portion 31 while being inverted about the center axis of the tubular portion 31 with respect to the proper posture, the insertion of the cover 70 into the tubular portion 31 is restricted by the contact of the first coupling wall 93 with the terminal 10. In this way, the worker easily notices the erroneous assembling of the cover 70 with the tubular portion 31.
(6) The interlock connector IC is provided in parallel to the two terminals 10 in the X-axis direction.

According to this configuration, an increase in the size of the housing 30 in the Y-axis direction can be suppressed, for example, as compared to the case where the terminals 10 and the interlock connector IC are arranged in parallel in the Y-axis direction orthogonal to the parallel direction of the two terminals 10.
(7) The tubular portion 31 includes the first partition wall 33 partitioning the inside of the tubular portion 31 between the two terminals 10 and the interlock connector IC.

According to this configuration, since the first partition wall 33 is provided inside the tubular portion 31, an insulation distance between the terminals 10 and the interlock connector IC can be reduced as compared to the case where the first partition wall 33 is not provided. Therefore, an increase in the size of the connector C1 in the X-axis direction can be suppressed.

### Modifications

This embodiment can be modified and carried out as follows. This embodiment and the following modifications can be carried out in combination without technically contradicting each other.
The first partition wall 33 may be omitted from the tubular portion 31.
The accommodating portion 95 may be omitted from the cover body 80.
The interlock connector IC may be provided in parallel to the terminals 10 in the Y-axis direction.
The interlock connector IC may be omitted from the connector C1.
At least one of the separation wall 91, the facing wall 92, the first coupling wall 93 and the second coupling wall 94 may be omitted from the cover body 80. If the first coupling wall 93 is omitted from the cover body 80, the cover body 80 preferably includes the accommodating portion 95. According to this configuration, if the cover 70 is inserted into the tubular portion 31 while being inverted about the center axis of the tubular portion 31 with respect to the proper position, the accommodating portion 95 contacts the first extending portion 11 of the terminal 10. In this way, the insertion of the cover 70 into the tubular portion 31 is restricted. Thus, the worker easily notices the erroneous assembling of the cover 70 with the tubular portion 31.
The rib 45 may be provided on the side where the first end part 31a is located when viewed from the holding portion 43.
The rib 45 may project from an arbitrary part of the outer surface of the holding portion 43.
The cross-sectional shape of the recess 46 of the rib 45 orthogonal to the Z-axis direction may be, for example, a circular shape, a polygonal shape or the like.
The recess 46 may be recessed in an arbitrary direction such as the X-axis direction or Y-axis direction in accordance with a pulling direction of the mold M.
The rib 45 may include a plurality of recesses 46.
The housing 30 may include a plurality of ribs 45.

List of Reference Numerals

| α | angle |
|---|---|
| B | battery |
| C1, C2 | connector |
| IC | interlock connector |
| L1 | first virtual axis |
| L2 | second virtual axis |
| L3 | third virtual axis |
| M | mold |
| M1 | electric device (connection target) |
| M2 | electric device |
| P | intersection |
| V | vehicle |
| W1, W2 | wiring harness |
| 10 | terminal |
| 11 | first extending portion |
| 12 | second extending portion |
| 13 | third extending portion |
| 13a | bolt hole |
| 14 | wire connecting portion |
| 20 | wire |
| 21 | core wire |
| 22 | insulation coating |
| 30 | housing |
| 31 | tubular portion |
| 31a | first end part |
| 31b | second end part |
| 32 | opening |
| 33 | first partition wall (partition wall) |
| 34 | second partition wall |
| 34a | insertion hole |
| 35 | inserting portion |
| 36 | first accommodation groove |
| 37 | groove body |
| 38A, 38B | engaged portion |
| 39 | first engaging groove |
| 40 | second engaging groove |
| 41 | fixing portion |
| 42 | collar |
| 43 | holding portion |
| 44 | second accommodation groove |
| 45 | rib |
| 46 | recess |
| 50 | first sealing member |
| 51 | sealing body |
| 52A, 52B | engaging portion |
| 53 | first engaging projection |
| 54 | second engaging projection |
| 60 | second sealing member |
| 70 | cover |
| 80 | cover body |
| 81 | lid portion |
| 81a | vent |
| 81b | partitioning portion |
| 82 | third accommodation groove |
| 83 | boss |
| 84 | first supporting protrusion |
| 85 | second supporting protrusion |
| 86 | inner wall |
| 86a | first end edge |
| 86b | second end edge |
| 87a | first extending portion |
| 87b | second extending portion |
| 88 | inner discharge port |
| 89 | outer wall |
| 90 | outer discharge port |
| 91 | separation wall |
| 92 | facing wall |
| 93 | first coupling wall |
| 94 | second coupling wall |
| 95 | accommodating portion |
| 100 | breathable film |
| 110 | third sealing member |
| 120 | shield shell |
| 130 | first shell |
| 131 | first part |
| 132 | opening |
| 133 | fixing projection |
| 133a | screw hole |
| 134 | fixing portion |
| 134a | through hole |
| 135 | second part |
| 136 | projecting portion |
| 136a | screw hole |
| 140 | second shell |
| 141 | projecting portion |
| 141a | through hole |
| 150 | third shell |
| 151 | through hole |
| 152 | boss insertion hole |
| 153 | first insertion hole |
| 154 | second insertion hole |
| 160 | bolt |
| 170 | tap screw |
| 200 | case |
| 201 | insertion hole |
| 202 | screw hole |
| 210 | mating terminal |

1. A connector, comprising:
a plurality of terminals parallel to each other;
a plurality of wires to be respectively connected to the plurality of terminals; and
a housing made of resin and including a tubular portion having an opening for exposing end parts of the plurality of terminals and a holding portion projecting from the tubular portion toward an outer peripheral side of the tubular portion, the holding portion holding the plurality of terminals and the plurality of wires,
the housing including a rib coupling an outer surface of a part of the holding portion located between two mutually adjacent ones of the terminals and an outer surface of the tubular portion, and
the rib including a recess.

2. The connector of claim 1, wherein, if parts of the terminals to be connected to the wires are wire connecting portions, the rib projects from an outer surface of a part of the holding portion located between two mutually adjacent ones of the wire connecting portions.

3. The connector of claim 1, comprising a cover for covering the opening by being inserted into the tubular portion, wherein:
the tubular portion has a first end part, the cover being inserted into the first end part, and a second end part located on a side opposite to the first end part in an axial direction of the tubular portion,
the holding portion projects from the first end part, and
the rib is provided on a side where the second end part is located when viewed from the holding portion.

4. The connector of claim 3, wherein the cover includes a separation wall made of resin and located between two mutually adjacent ones of the terminals.

5. The connector of claim 4, wherein:
the cover includes:
a facing wall located on a side opposite to the separation wall across one terminal fitting and facing the separation wall; and
a coupling wall located on a side opposite to the holding portion across the one terminal and coupling the separation wall and the facing wall, and
the coupling wall is configured to restrict insertion of the cover into the tubular portion by contacting the terminal if the cover is inserted into the tubular portion while being inverted about a center axis of the tubular portion with respect to a proper posture.

6. The connector of claim 1, comprising an interlock connector provided inside the tubular portion, the interlock connector electrically detecting whether or not the housing is connected to a connection target at a proper position, wherein:
the interlock connector is provided in parallel to the plurality of terminals in a parallel direction of the plurality of terminals.

7. The connector of claim 6, comprising a cover for covering the opening by being inserted into the tubular portion, wherein:
the cover includes an accommodating portion for accommodating one end of the interlock connector, and
the accommodating portion is configured to restrict insertion of the cover into the tubular portion by contacting the terminal if the cover is inserted into the tubular portion while being inverted about a center axis of the tubular portion with respect to a proper posture.

8. The connector of claim 6, wherein the tubular portion includes a partition wall partitioning inside of the tubular portion between the plurality of terminals and the interlock connector.
